(19) United States
(12) Patent Application Publication
(10) Pub. No.: US 2026/0340056 A1
(43) Pub. Date: Oct. 29, 2026

(54) SEARCH RESULT DISPLAY METHOD AND APPARATUS, COMPUTER DEVICE AND STORAGE MEDIUM

(71) Applicant: Beijing Zitiao Network Technology Co., Ltd., Beijing (CN)

(72) Inventors: Mengna TONG, Beijing (CN); Liping ZHU, Beijing (CN)

(21) Appl. No.: 19/103,807

(22) PCT Filed: Apr. 9, 2024
(86) PCT No.: PCT/CN2024/086769

§ 371 Date: Feb. 13, 2025

(30) Foreign Application Priority Data
Apr. 10, 2023 (CN) 202310377180.4

(51) Int. Cl. G06F 16/9538; G06F 40/30

(52) U.S. Cl. CPC G06F 16/9538; G06F 40/30

(57) ABSTRACT

A search result display method, a computer device, and a storage medium are disclosed. The method includes: acquiring search results corresponding to target search information in response to receiving the target search information; acquiring at least one piece of recommended content matching with the target search information in response to a first search result in the search results being a search result that satisfies a first preset condition, where any piece of the recommended content includes recommended search information and a recommended search result corresponding to the recommended search information; and displaying the first search result at a first display position of a search result page, and inserting the recommended content into a target display position after the first search result for display.

The present application claims priority to Chinese Patent Application No. 202310377180.4 filed on Apr. 10, 2023, the disclosure of which is incorporated herein by reference in its entirety as part of the present application.

### TECHNICAL FIELD

Embodiments of the present disclosure relate to a search result display method and apparatus, a computer device, and a storage medium.

### BACKGROUND

With the development of Internet technologies, more and more users can search through the Internet to obtain desired information.

When a user uses a search term to search, generally, there are many search results with the same or similar content in the obtained search results, and there are also many search results that are not highly relevant to the user's needs. The valuable content in these search results is limited, which wastes display resources and affects the efficiency of the user in obtaining effective information.

### SUMMARY

Embodiments of the present disclosure provide at least a search result display method and apparatus, a computer device, and a storage medium.

In a first aspect, an embodiment of the present disclosure provides a search result display method, including:
acquiring search results corresponding to target search information in response to receiving the target search information;
acquiring at least one piece of recommended content matching with the target search information in response to a first search result in the search results being a search result that satisfies a first preset condition, where any piece of the recommended content includes recommended search information and a recommended search result corresponding to the recommended search information; and
displaying the first search result at a first display position of a search result page, and inserting the recommended content into a target display position after the first search result for display.

In an optional embodiment, the inserting the recommended content into a target display position after the first search result for display includes:
inserting and displaying the recommended content after the first search result corresponding to the target search information and before another search result corresponding to the target search information.

In an optional embodiment, the inserting and displaying the recommended content after the first search result corresponding to the target search information and before another search result corresponding to the target search information includes:
displaying target recommended content in the recommended content and first indication information indicating that more pieces of recommended content are triggered to view after the first search result corresponding to the target search information and before another search result corresponding to the target search information, where other pieces of recommended content are displayed after the first indication information is triggered.

In an optional embodiment, the inserting and displaying the recommended content after the first search result corresponding to the target search information and before another search result corresponding to the target search information includes:
displaying second indication information indicating that subsequent content is the recommended content after the first search result corresponding to the target search information and before another search result corresponding to the target search information, and sequentially displaying the recommended content under the second indication information.

In an optional embodiment, the inserting the recommended content into a target display position after the first search result for display includes:
sequentially inserting different pieces of recommended content between adjacent search results in a plurality of consecutive search results corresponding to the target search information, where the plurality of consecutive search results include the first search result.

In an optional embodiment, the acquiring at least one piece of recommended content matching with the target search information includes:
determining at least one piece of recommended search information matching with the target search information according to a pre-established offline mapping relationship between pieces of original search information and the recommended search information, and using a first search result in search results corresponding to the recommended search information as the recommended search result.

In an optional embodiment, the pre-established offline mapping relationship between the pieces of original search information and the recommended search information is determined according to the following steps:
determining recommended search information corresponding to the original search information based on semantic information corresponding to search information and a historical search frequency corresponding to the search information, where a semantic information similarity between the recommended search information and the original search information satisfies a second preset condition, or semantic information of the recommended search information and semantic information of the original search information indicate a same search type, and a historical search frequency corresponding to the recommended search information reaches a first preset threshold.

In an optional embodiment, the acquiring at least one piece of recommended content matching with the target search information in response to a first search result in the search results being a search result that satisfies a first preset condition includes:

acquiring at least one piece of recommended content matching with the target search information in response to the target search information corresponding to an objective answer and the objective answer being the first search result.

In an optional embodiment, the acquiring at least one piece of recommended content matching with the target search information in response to the target search information corresponding to the objective answer and an objective answer being the first search result includes:
acquiring at least one piece of recommended content matching with the target search information in response to the target search information corresponding to an objective answer and the objective answer being the first search result, and a historical search frequency of searching using the target search information reaching a second preset threshold.

In a second aspect, an embodiment of the present disclosure further provides a search result display apparatus, including:
a first acquisition module, configured to acquire search results corresponding to target search information in response to receiving the target search information;
a second acquisition module, configured to acquire at least one piece of recommended content matching with the target search information in response to a first search result in the search results being a search result that satisfies a first preset condition, where any piece of the recommended content includes recommended search information and a recommended search result corresponding to the recommended search information; and
a display module, configured to display the first search result at a first display position of a search result page, and insert the recommended content into a target display position after the first search result for display.

In a third aspect, an embodiment of the present disclosure further provides a computer device, including: a processor, a memory, and a bus, where the memory stores machine-readable instructions executable by the processor; when the computer device is running, the processor communicates with the memory through the bus; and the machine-readable instructions, when executed by the processor, perform the steps in the first aspect or any optional embodiment of the first aspect.

In a fourth aspect, an embodiment of the present disclosure further provides a computer-readable storage medium, where the computer-readable storage medium stores a computer program, and the computer program, when executed by a processor, performs the steps in the first aspect or any optional embodiment of the first aspect.

In order to make the above objects, features and advantages of the present disclosure more comprehensible, embodiments are described in detail below with reference to the drawings.

### BRIEF DESCRIPTION OF DRAWINGS

In order to illustrate the technical solutions of the embodiments of the present disclosure more clearly, the drawings required for describing the embodiments will be briefly described below. The drawings are incorporated in and constitute a part of this specification, and illustrate embodiments consistent with the present disclosure and, together with the description, serve to explain the technical solutions of the present disclosure. It should be understood that the following drawings illustrate only some embodiments of the present disclosure, and therefore should not be regarded as limiting the scope of the present disclosure. For those of ordinary skill in the art, other related drawings can be obtained from these drawings without creative effort.

FIG. 1 is a flowchart of a search result display method according to an embodiment of the present disclosure;

FIG. 2 is a schematic diagram of effects of a search result page according to an embodiment of the present disclosure;

FIG. 3 is a schematic diagram of effects of another search result page according to an embodiment of the present disclosure;

FIG. 4 is a schematic diagram of effects of another search result page according to an embodiment of the present disclosure;

FIG. 5 is a schematic diagram of effects of another search result page according to an embodiment of the present disclosure;

FIG. 6 is a schematic diagram of a structure of a search result display apparatus according to an embodiment of the present disclosure; and

FIG. 7 is a schematic diagram of a computer device according to an embodiment of the present disclosure.

### DETAILED DESCRIPTION

In order to make the objectives, technical solutions, and advantages of the embodiments of the present disclosure clearer, the technical solutions in the embodiments of the present disclosure will be described clearly and completely below with reference to the drawings in the embodiments of the present disclosure. Obviously, the described embodiments are only a part of the embodiments of the present disclosure, rather than all of the embodiments. Generally, the components of the embodiments of the present disclosure described and illustrated in the drawings may be arranged and designed in various different configurations. Therefore, the following detailed description of the embodiments of the present disclosure provided in the drawings is not intended to limit the scope of the claimed present disclosure, but merely represents selected embodiments of the present disclosure. Based on the embodiments of the present disclosure, all other embodiments obtained by those skilled in the art without creative effort fall within the protection scope of the present disclosure.

A user may obtain a lot of search results after initiating a search, where there are a lot of search results with the same or similar content, and there are also a lot of search results that are not highly relevant to the user's needs. Since the valuable content in these search results is limited, page resources are wasted. At the same time, due to the limited effective information that the user can obtain by reading these search results, the user's reading time is also wasted, which affects the efficiency of the user in obtaining effective information.

Therefore, how to display more valuable content for the user while satisfying the user's search needs and improve the efficiency of obtaining effective information is a problem to be solved by embodiments of the present disclosure.

Based on this, the present disclosure provides a search result display method, including: acquiring various search results corresponding to target search information in response to receiving the target search information; acquiring at least one piece of recommended content matching with the target search information in response to a first search result in the various search results being a search result that satisfies a first preset condition; and displaying the first search result at a first display position of a search result page, and inserting the recommended content into a target display position after the first search result for display.

In the embodiment of the present disclosure, among the search results returned by the search engine, if the first search result satisfies the first preset condition, for example, the search requirement for the target search information may be satisfied, some recommended search information and search results matching therewith may be displayed after the first search result, and the recommended search information may be recommended according to the target search information input by the user. In this way, after the first search result allows the user to quickly obtain the answer that satisfies the initial search requirement, the user may obtain more valuable information. In this way, on one hand, the user does not need to waste a lot of time reading some search results with the same or similar content as the first search result or some search results that are not highly relevant to the user's needs, and on the other hand, the user can quickly obtain the recommended content that satisfies the potential search requirement, thereby improving the efficiency of obtaining effective information.

The defects in the above solutions and the proposed solutions are all results obtained by the inventors after practice and careful study. Therefore, the discovery process of the above problems and the solutions to the above problems proposed by the present disclosure below should be contributions of the inventors to the present disclosure during the process of the present disclosure.

It should be noted that similar reference numerals and letters represent similar items in the following drawings. Therefore, once an item is defined in a drawing, it does not need to be further defined and explained in subsequent drawings.

It can be understood that before using the technical solutions disclosed in the embodiments of the present disclosure, the user should be informed of the type, use range, use scenario, etc. of the personal information involved in the present disclosure in an appropriate manner and obtain the user's authorization according to relevant laws and regulations.

In order to facilitate understanding of this embodiment, a search result display method disclosed in an embodiment of the present disclosure is first introduced in detail. The execution body of the search result display method provided in the embodiments of the present disclosure is generally a computer device with a certain computing power.

The search result display method provided by the embodiments of the present disclosure will be described below by taking the execution body as a terminal device as an example.

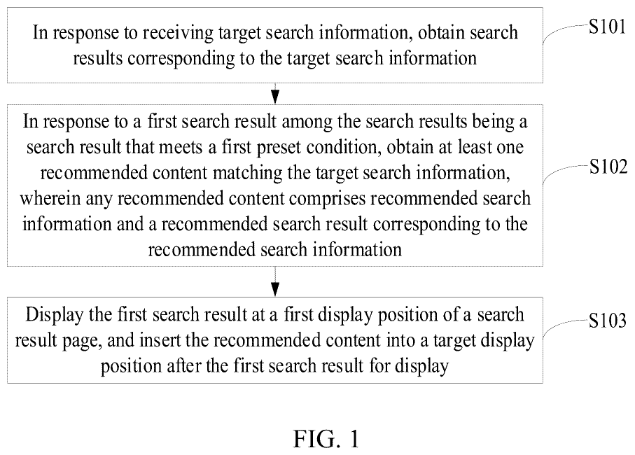

Referring to FIG. 1, it is a flowchart of a search result display method according to an embodiment of the present disclosure. The method includes S101 to S103.

S101: acquiring search results corresponding to target search information in response to receiving the target search information.

In the embodiment of the present disclosure, after receiving the target search information input by the user, the search results returned by the search engine may be acquired. The target search information here may match some pre-stored original search information, and each piece of the original search information is search information that may display related recommended content on a search result page. The original search information may correspond to an objective answer, and may also correspond to a certain search popularity, for example, a historical search frequency within a preset time period reaches a preset number of times.

Here, the target search information matching with the original search information may refer to that the target search information is the same as or close in meaning to the original search information.

Based on the above description, the objective answer may be included in the search results corresponding to the target search information returned by the search engine. For example, the target search information may be “which oceans are on the earth”, and the search results corresponding to the target search information may include an objective answer such as “Pacific Ocean, Atlantic Ocean, Indian Ocean, and Arctic Ocean”.

S102: acquiring at least one piece of recommended content matching with the target search information in response to a first search result in the search results being a search result that satisfies a first preset condition, where any piece of the recommended content includes recommended search information and a recommended search result corresponding to the recommended search information.

Here, in the case where the first search result is the search result that satisfies the first preset condition, the user can obtain the answer that meets the initial search requirement according to the first search result, without the need to browse other search results too much. At this time, at least one piece of recommended content matching with the target search information may be acquired, so that the recommended content matching with the target search information can be displayed.

Continuing from the above description, the first search result satisfying the first preset condition may specifically include that the first search result is an objective answer (this is only an implementation, and the first preset condition may also be another preset condition, such as the matching degree with the target search information being higher than a certain threshold, etc.), that is, in the case where the objective answer in the various search results is used as the first search result, the recommended content matching with the target search information is synchronously acquired. That is, in an implementation, the above S102 may include: acquiring at least one piece of recommended content matching with the target search information in response to the target search information corresponding to an objective answer and the objective answer being the first search result.

When the objective answer in the various search results is used as the first search result, the user can obtain the answer that meets the search requirement according to the objective answer, and at this time, the recommended content matching with the target search information can be acquired. By acquiring the recommended content matching with the target search information, more valuable content that may be of interest to the user can be displayed, thereby satisfying the user's potential search requirement and improving the efficiency of obtaining effective information. The process of acquiring the recommended content matching with the target search information and displaying the recommended content will be described in detail below.

In order to more accurately meet the user's search requirement, in an implementation, while the first search result is the objective answer, the recommended content matching with the target search information may also be acquired in the case where the historical search frequency of searching using the target search information reaches a second preset threshold. That is, in an implementation, the above S102 may specifically include: acquiring at least one piece of recommended content matching with the target search information in response to the target search information corresponding to an objective answer and the objective answer being the first search result, and the historical search frequency of searching using the target search information reaching a second preset threshold.

When the condition that the historical search frequency of searching using the target search information reaches the second preset threshold is satisfied, it may indicate that the search requirement corresponding to the target search information is relatively strong. In this case, the potential search requirement related to the target search information is generally relatively strong. Therefore, in the above two conditions, that is, the target search information corresponding to the objective answer and the objective answer being the first search result, and the historical search frequency of searching using the target search information reaching the second preset threshold, at least one piece of recommended content matching with the target search information is acquired, so that content that is more consistent with the user's potential search requirement can be selected, and the efficiency and accuracy of obtaining information can be improved. The process of acquiring the recommended content matching with the target search information and displaying the recommended content will be described in detail below.

Here, any piece of the recommended content may include recommended search information and a recommended search result corresponding to the recommended search information.

The recommended search information may be search information related to the target search information, for example, search information that belongs to the same hotspot event as the target search information, or the same search type as the target search information, or corresponds to the same entity object as the target search information. For example, when other users use the target search information to search, some recommended search information will be displayed in “searches by everyone”, which can be used as recommended search information related to the target search information.

Here, the mapping relationship between the various pieces of original search information and the recommended search information may be pre-established offline. When acquiring the at least one piece of recommended content matching with the target search information, at least one piece of recommended search information matching with the target search information may be determined according to the mapping relationship between the various pieces of original search information and the recommended search information which is pre-established, and a first search result in various search results corresponding to the recommended search information is used as the recommended search result.

As mentioned above, the target search information may match with the above original search information (the same or similar). Therefore, the recommended search information matching with the target search information may be determined here according to the mapping relationship between the various pieces of original search information and the recommended search information which is pre-established and the target search information. Here, each piece of the original search information may correspond to at least one piece of recommended search information, so at least one piece of recommended search information matching with the target search information may be determined.

The search results corresponding to the recommended search information may include search results after searching using the recommended search information. Each piece of the recommended search information may correspond to at least one search result, and the first search result in the search results corresponding to the recommended search information may be used as the recommended search result here.

In the case where the determined recommended search information matching with the target search information includes a plurality of pieces, the first search results corresponding to the plurality of pieces of recommended search information respectively may be used as the recommended search results, that is, a plurality of pieces of recommended search results matching with the target search information may also be included.

In an implementation, the aforementioned mapping relationship between the various pieces of original search information and the recommended search information which is pre-established offline may be determined through the following steps: determining the recommended search information corresponding to the original search information based on semantic information corresponding to each piece of search information and a historical search frequency corresponding to each piece of search information.

A semantic information similarity between the recommended search information and the original search information satisfies a second preset condition, or semantic information of the recommended search information and that of the original search information indicate a same search type, and a historical search frequency corresponding to the recommended search information reaches a first preset threshold. That is, the semantic information similarity between the recommended search information and the original search information satisfies the second preset condition, and the historical search frequency corresponding to the recommended search information reaches the first preset threshold; or, the semantic information of the recommended search information and that of the original search information indicate the same search type, and the historical search frequency corresponding to the recommended search information reaches the first preset threshold.

Here, the second preset condition may include being greater than a third set threshold and less than a fourth set threshold, that is, the semantic information similarity between the recommended search information and the original search information is greater than the third set threshold and less than the fourth set threshold. The recommended search information may include recommended search information related to but different from the original search information. Therefore, by setting the second preset condition greater than the third set threshold and less than the fourth set threshold, a mapping relationship between the recommended search information related to but different from the original search information and the original search information may be established (it may be understood here that: the recommended search information with the semantic information similarity with the original search information being less than or equal to the third set threshold is the recommended search information not related to the target search information; the recommended search information with the semantic information similarity with the original search information being greater than or equal to the fourth set threshold is the recommended search information the same as the target search information). For example, the original search information may be “which oceans are on the earth”, and the recommended search information may be “which ocean is the largest ocean”. It can be seen that the original search information is semantically related to but different from the recommended search information.

By establishing the mapping relationship between the recommended search information with the semantic information similarity satisfying the second preset condition and the original search information, on one hand, the user can obtain more pieces of recommended content related to the target search information, and on the other hand, repeated recommended content can be avoided, so that the user's search requirement can be better satisfied, and the efficiency and accuracy of obtaining information can be improved.

The recommended search information and the original search information have the same search type indicated by semantic information, for example, the original search information may be “which oceans are on the earth”, and the recommended search information may be “which continents are on the earth”. The original search information and the recommended search information have different semantic information, but the search type may be the same. By establishing the mapping relationship between the recommended search information having the same search type as the search type indicated by the semantic information of the original search information and the original search information, more pieces of recommended content in the same search type can be displayed, thereby enriching the displayed content and satisfying the user's search requirement.

The historical search frequency corresponding to the recommended search information may refer to the historical search frequency of searching using the recommended search information. Here, by establishing the mapping relationship between the recommended search information with the corresponding historical search frequency reaching the first preset threshold and the original search information, the recommended search information with a higher historical search frequency can be displayed on the search result page, so that the displayed recommended content can be more consistent with the user's search requirement, thereby improving the efficiency and accuracy of obtaining information.

S103, displaying the first search result at a first display position of a search result page, and inserting the recommended content into a target display position after the first search result for display.

Here, the recommended content may be inserted into the target display position after the first search result according to a preset rule.

In an implementation, the recommended content may be inserted and displayed after the first search result corresponding to the target search information and before another search result corresponding to the target search information.

Here, the another search result corresponding to the target search information may include another search result other than the first search result in the search results corresponding to the target search information. That is, on the search result page, the first search result may be displayed at the first display position first, the recommended content is displayed after the first search result, and the another search result is displayed after the recommended content.

Considering the case where there is much more pieces of recommended content in practice, in an implementation, target recommended content in the multiple pieces of recommended content and first indication information indicating that more pieces of recommended content are triggered to view may be displayed after the first search result corresponding to the target search information and before another search result corresponding to the target search information, where the other pieces of recommended content are displayed after the first indication information is triggered. In a manner, in order to better prompt the user, the first indication information may be highlighted, for example, bolded.

That is, the first search result may be displayed at the first display position first, the target recommended content in the multiple pieces of recommended content and the first indication information (the first indication information may be displayed after the target recommended content) are displayed after the first search result. Before the first indication information is triggered, another search result is displayed after the first indication information. After the first indication information is triggered, another piece of recommended content is displayed after the target recommended content, and another search result is displayed after the another piece of recommended content.

Here, displaying the target recommended content in the multiple pieces of recommended content, that is, partial pieces of recommended content. That is, before the first indication information is triggered, the other pieces of recommended content may be folded, and after the first indication information is triggered, the other pieces of recommended content may be displayed.

The target recommended content may include partial pieces of recommended content randomly selected from the multiple pieces of recommended content, or may include target recommended content selected after sorting the multiple pieces of recommended content based on the historical search frequency corresponding to the recommended search information, and the historical search frequency of the target recommended content satisfies a third preset condition (for example, greater than a fifth set threshold), or may include target recommended content corresponding to the recommended search information selected after the semantic information similarity between the recommended search information and the original search information satisfies a fourth preset condition (for example, greater than a sixth set threshold). The selection process of the target recommended content here may not be specifically limited.

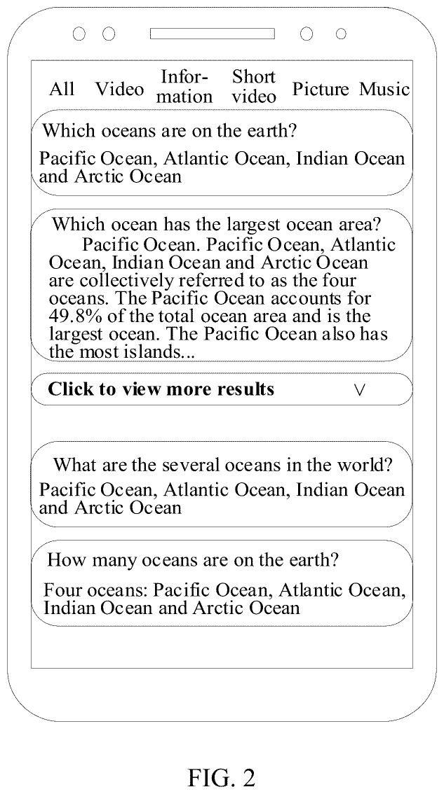

FIG. 2 is a schematic diagram of effects of a search result page. When the target search information is “which oceans are on the earth”, the determined first search result, that is, “which oceans are on the earth? Pacific Ocean, Atlantic Ocean, Indian Ocean, and Arctic Ocean” may be displayed at the first display position of the search result page.

A piece of target recommended content may be displayed under the first search result, that is, “which ocean has the largest ocean area? Pacific Ocean. Pacific Ocean, Atlantic Ocean, Indian Ocean, and Arctic Ocean are collectively referred to as the four oceans. The Pacific Ocean accounts for 49.8% of the total ocean area and is the largest ocean. The Pacific Ocean also has the most islands . . . ”, and indication information indicating that more pieces of recommended content is triggered to view: “click to display more results”. After the user triggers the indication information “click to display more results”, other pieces of recommended content may be displayed. In order to prompt the user, the indication information may be displayed in bold.

Other search results may be displayed under the indication information, that is, “what are the several oceans in the world? Pacific Ocean, Atlantic Ocean, Indian Ocean, and Arctic Ocean” and “how many oceans are on the earth? Four oceans: Pacific Ocean, Atlantic Ocean, Indian Ocean, and Arctic Ocean”.

In order to make it easier for the user to find the recommended content, in an implementation, second indication information indicating that subsequent content is the recommended content may be displayed after the first search result corresponding to the target search information and before another search result corresponding to the target search information, and the recommended content is sequentially displayed under the second indication information. In a manner, in order to better prompt the user, the second indication information may be highlighted. The display mode of the second indication information may be the same as or different from the display mode of the first indication information.

That is, the first search result may be displayed at the first display position first, the second indication information is displayed after the first search result, the recommended content is displayed under the second indication information, and another search result is displayed after the recommended content.

Here, the second indication information may indicate the display position of the recommended content, that is, the display position of the recommended content is below the second indication information.

The recommended content may be sequentially displayed according to a preset display sequence. In a specific implementation, the recommended content may be displayed according to a display sequence determined based on the historical search frequency corresponding to the recommended search information, for example, the recommended content is displayed in an order of the historical search frequency from high to low, or the recommended content may be displayed according to a display sequence determined based on the semantic information similarity between the recommended search information and the original search information, for example, the recommended content is displayed in an order of the semantic information similarity from large to small. The display sequence of the recommended content here may not be specifically limited.

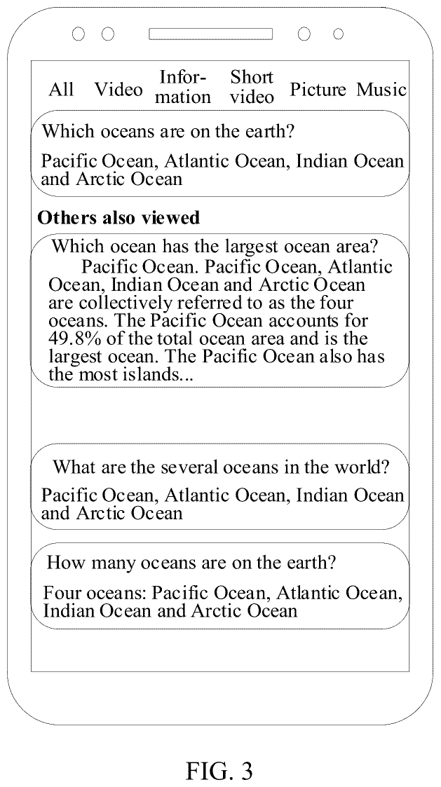

FIG. 3 is a schematic diagram of effects of another search result page. When the target search information is “which oceans are on the earth”, the determined first search result, that is, “which oceans are on the earth? Pacific Ocean, Atlantic Ocean, Indian Ocean, and Arctic Ocean” may be displayed at the first display position of the search result page.

Indication information indicating that subsequent content is the recommended content: “others also viewed” may be displayed under the first search result. In order to prompt the user, the indication information may be displayed in bold.

A target recommended content may be displayed under the indication information, that is, “which ocean has the largest ocean area? Pacific Ocean. Pacific Ocean, Atlantic Ocean, Indian Ocean, and Arctic Ocean are collectively referred to as the four oceans. The Pacific Ocean accounts for 49.8% of the total ocean area and is the largest ocean. The Pacific Ocean also has the most islands . . . ”.

Other search results may be displayed under the target recommended content, that is, “what are the several oceans in the world? Pacific Ocean, Atlantic Ocean, Indian Ocean, and Arctic Ocean” and “how many oceans are on the earth? Four oceans: Pacific Ocean, Atlantic Ocean, Indian Ocean, and Arctic Ocean”.

In an implementation, the recommended content may also be displayed after the first search result corresponding to the target search information and another search result corresponding to the target search information.

That is, the first search result may be displayed at the first display position first, another search result is displayed after the first search result, and the recommended content is displayed after the another search result.

Here, displaying the recommended content may include displaying target recommended content in the multiple pieces of recommended content and third indication information indicating that more pieces of recommended content are triggered to view, where the other pieces of recommended content are displayed after the third indication information is triggered. For the specific process, reference may be made to the process of displaying the first indication information mentioned above, which will not be described in detail here.

Displaying the recommended content may also include sequentially displaying the recommended content. In a manner, before sequentially displaying the recommended content, fourth indication information indicating that subsequent content is the recommended content may also be displayed, and the recommended content is sequentially displayed under the fourth indication information. For the process of sequentially displaying the recommended content, reference may be made to the foregoing description, which will not be repeated here.

In the case where there are many other search results, in a manner, a target another search result in the multiple other search results and fifth indication information indicating that more other search results are triggered to view may also be displayed. Here, the target another search result may be partial other search results randomly selected from the multiple other search results, or may be selected according to a preset selection rule, which will not be described in detail here. In a manner, only the fifth indication information indicating that more other search results are triggered to view may also be displayed. After the fifth indication information is triggered, another search result may be displayed.

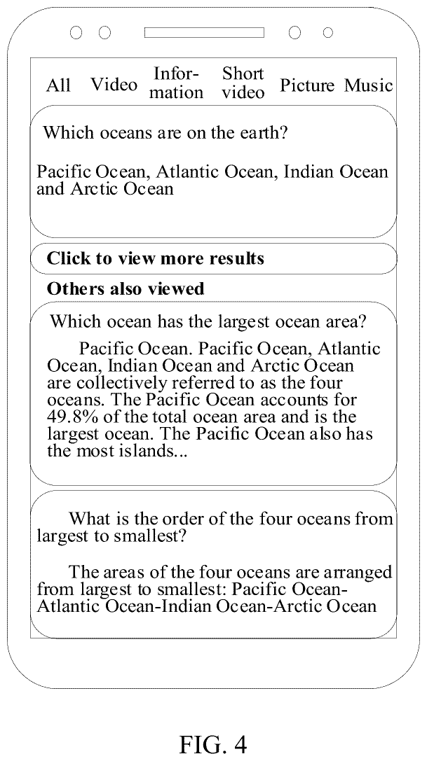

FIG. 4 is a schematic diagram of effects of another search result page. When the target search information is “which oceans are on the earth”, the determined first search result, that is, “which oceans are on the earth? Pacific Ocean, Atlantic Ocean, Indian Ocean, and Arctic Ocean” may be displayed at the first display position of the search result page.

Indication information indicating that more other search results are triggered to view: “click to display more results” may be displayed under the first search result. After the user triggers the indication information “click to display more results”, other search content may be displayed.

Indication information indicating that subsequent content is the recommended content: “others also viewed” may be displayed under the indication information. Recommended content may be displayed under the indication information: “which ocean has the largest ocean area? Pacific Ocean. Pacific Ocean, Atlantic Ocean, Indian Ocean, and Arctic Ocean are collectively referred to as the four oceans. The Pacific Ocean accounts for 49.8% of the total ocean area and is the largest ocean. The Pacific Ocean also has the most islands . . . ” and “what is the order of the four oceans from largest to smallest? The areas of the four oceans are arranged from largest to smallest: Pacific Ocean-Atlantic Ocean-Indian Ocean-Arctic Ocean”. In order to prompt the user, the above two pieces of indication information may be displayed in bold.

In an implementation, the recommended content may also be displayed without the user's perception, that is, the recommended content may be displayed after being fused with other search results. In a specific implementation, different pieces of recommended content may be sequentially inserted between adjacent search results in a plurality of consecutive search results corresponding to the target search information.

Here, the plurality of consecutive search results may include the first search result. That is, the different pieces of recommended content may be displayed at a second display position, a fourth display position, a sixth display position, etc. of the search result page. In this way, after the first search result, the multiple pieces of recommended content and the multiple other search results may be displayed alternately, so that the user can browse more valuable pieces of recommended content and the search results corresponding to the target search information in the search results without perception, thereby better satisfying the user's search requirement.

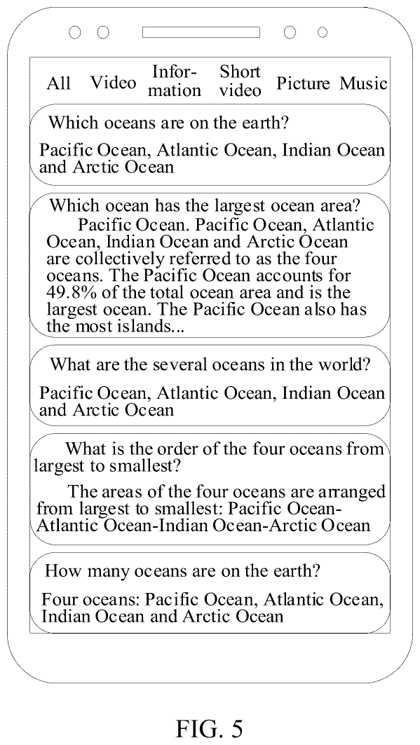

As shown in FIG. 5, which is a schematic diagram of effects of another search result page, when the target search information is “which oceans are on the earth”, the determined first search result, that is, “which oceans are on the earth? Pacific Ocean, Atlantic Ocean, Indian Ocean, and Arctic Ocean” may be displayed at the first display position of the search result page.

The first recommended content may be displayed under the first search result, that is, at the second display position, that is, “which ocean has the largest ocean area? Pacific Ocean. Pacific Ocean, Atlantic Ocean, Indian Ocean, and Arctic Ocean are collectively referred to as the four oceans. The Pacific Ocean accounts for 49.8% of the total ocean area and is the largest ocean. The Pacific Ocean also has the most islands . . . ”.

The first other search result may be displayed under the first recommended content, that is, at the third display position, that is, “what are the several oceans in the world? Pacific Ocean, Atlantic Ocean, Indian Ocean, and Arctic Ocean”.

The second recommended content may be displayed under the first other search result, that is, at the fourth display position, that is, “what is the order of the four oceans from largest to smallest? The areas of the four oceans are arranged from largest to smallest: Pacific Ocean-Atlantic Ocean-Indian Ocean-Arctic Ocean”.

The second other search result may be displayed under the second recommended content, that is, at the fifth display position, that is, “how many oceans are on the earth? Four oceans: Pacific Ocean, Atlantic Ocean, Indian Ocean, and Arctic Ocean”.

It can be understood by those skilled in the art that in the above method of the specific implementation, the writing sequence of each step does not mean a strict execution sequence and constitutes any limitation on the implementation process, and the specific execution sequence of each step should be determined by its function and possible internal logic.

Based on the same inventive concept, an embodiment of the present disclosure further provides a search result display apparatus corresponding to the search result display method. Since the principle of solving the problem by the apparatus in the embodiment of the present disclosure is similar to the above search result display method in the embodiment of the present disclosure, the implementation of the apparatus may refer to the implementation of the method, and the repetitions will not be described again.

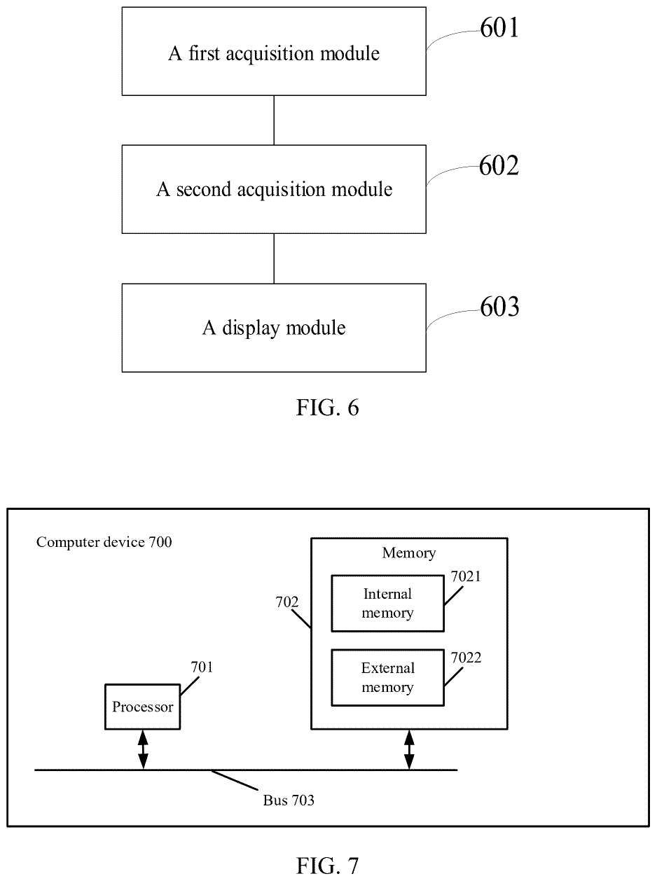

Referring to FIG. 6, it is a schematic diagram of an structure of a search result display apparatus according to an embodiment of the present disclosure. The apparatus includes:
a first acquisition module 601, configured to acquire search results corresponding to target search information in response to receiving the target search information;
a second acquisition module 602, configured to acquire at least one piece of recommended content matching with the target search information in response to a first search result in the search results being a search result that satisfies a first preset condition, where any piece of the recommended content includes recommended search information and a recommended search result corresponding to the recommended search information; and
a display module 603, configured to display the first search result at a first display position of a search result page, and insert the recommended content into a target display position after the first search result for display.

In an optional embodiment, the display module 603 is further configured to:
insert and display the recommended content after the first search result corresponding to the target search information and before another search result corresponding to the target search information.

In an optional embodiment, the display module 603 is further configured to:
display target recommended content in the recommended content and first indication information indicating that more pieces of recommended content are triggered to view after the first search result corresponding to the target search information and before another search result corresponding to the target search information, where other pieces of recommended content are displayed after the first indication information is triggered.

In an optional embodiment, the display module 603 is further configured to:
display second indication information indicating that subsequent content is the recommended content after the first search result corresponding to the target search information and before another search result corresponding to the target search information, and sequentially display the recommended content under the second indication information.

In an optional embodiment, the display module 603 is further configured to:
sequentially insert different pieces of recommended content between adjacent search results in a plurality of consecutive search results corresponding to the target search information, where the plurality of consecutive search results include the first search result.

In an optional embodiment, the second acquisition module 602 is further configured to:
determine at least one piece of recommended search information matching with the target search information according to a pre-established offline mapping relationship between pieces of original search information and the recommended search information, and use a first search result in search results corresponding to the recommended search information as the recommended search result.

In an optional embodiment, the apparatus further includes a determination module, configured to determine the mapping relationship between the various pieces of original search information and the recommended search information which is pre-established offline according to the following steps:
determining recommended search information corresponding to the original search information based on semantic information corresponding to search information and a historical search frequency corresponding to the search information, where a semantic information similarity between the recommended search information and the original search information satisfies a second preset condition, or semantic information of the recommended search information and semantic information of the original search information indicate a same search type, and a historical search frequency corresponding to the recommended search information reaches a first preset threshold.

In an optional embodiment, the second acquisition module 602 is further configured to:
acquire at least one piece of recommended content matching with the target search information in response to the target search information corresponding to an objective answer and the objective answer being the first search result.

In an optional embodiment, the second acquisition module 602 is further configured to:
acquire at least one piece of recommended content matching with the target search information, in response to the target search information corresponding to an objective answer and the objective answer being the first search result, and a historical search frequency of searching using the target search information reaching a second preset threshold.

For the description of the processing flow of each module in the apparatus and the interaction flow between the modules, reference may be made to the related description in the above method embodiments, which will not be described in detail here.

Based on the same technical concept, an embodiment of the present disclosure further provides a computer device. Referring to FIG. 7, it is a schematic diagram of a structure of a computer device 700 according to an embodiment of the present disclosure, including a processor 701, a memory 702, and a bus 703. The memory 702 is configured to store execution instructions, including an internal memory 7021 and an external memory 7022. The internal memory 7021 here is also called an internal storage, and is configured to temporarily store operation data in the processor 701 and data exchanged with an external memory 7022 such as a hard disk. The processor 701 exchanges data with the external memory 7022 through the internal memory 7021. When the computer device 700 is running, the processor 701 communicates with the memory 702 through the bus 703, so that the processor 701 executes the following instructions:
acquiring search results corresponding to target search information in response to receiving the target search information;
acquiring at least one piece of recommended content matching with the target search information in response to a first search result in the search results being a search result that satisfies a first preset condition, where any piece of the recommended content includes recommended search information and a recommended search result corresponding to the recommended search information; and
displaying the first search result at a first display position of a search result page, and inserting the recommended content into a target display position after the first search result for display.

The embodiment of the present disclosure further provides a computer-readable storage medium. The computer-readable storage medium stores a computer program, and the computer program, when executed by a processor, performs the steps of the search result display method described in the above method embodiments. The storage medium may be a volatile or non-volatile computer-readable storage medium.

The embodiment of the present disclosure further provides a computer program product. The computer program product carries program codes, and instructions included in the program codes may be used to perform the steps of the search result display method described in the above method embodiments. For details, reference may be made to the above method embodiments, which will not be described here again.

The above computer program product may be implemented in hardware, software, or a combination thereof. In an optional embodiment, the computer program product is embodied as a computer storage medium. In another optional embodiment, the computer program product is embodied as a software product, such as a software development kit (SDK) or the like.

It can be clearly understood by those skilled in the art that for the convenience and brevity of description, the specific working process of the system and the apparatus described above may refer to the corresponding process in the foregoing method embodiments, which will not be described here again. In several embodiments provided in the present disclosure, it should be understood that the disclosed system, apparatus, and method may be implemented in other manners. The apparatus embodiments described above are merely illustrative. For example, the division of the units is only a logical function division, and there may be other division manners in actual implementation. For another example, multiple units or components may be combined or integrated into another system, or some features may be ignored or not executed. In addition, the mutual coupling or direct coupling or communication connection shown or discussed may be through some communication interfaces, and the indirect coupling or communication connection between the apparatuses or units may be electrical, mechanical, or other forms.

The units described as separate parts may or may not be physically separated, and the parts displayed as units may or may not be physical units, that is, they may be located in one place or distributed on multiple network units. Some or all of the units may be selected according to actual needs to achieve the objectives of the solutions of the embodiments.

In addition, the functional units in the embodiments of the present disclosure may be integrated into one processing unit, or may exist alone physically, or two or more units may be integrated into one unit.

The functions may be stored in a non-volatile computer-readable storage medium executable by a processor when implemented in the form of software functional units and sold or used as independent products. Based on such understanding, the technical solutions of the present disclosure may be embodied in the form of software products, which are stored in a storage medium and include several instructions for causing a computer device (which may be a personal computer, a server, or a network device, etc.) to perform all or part of the steps of the methods described in the embodiments of the present disclosure. The aforementioned storage medium includes various media that can store program codes, such as a USB flash drive, a mobile hard disk, a read-only memory (ROM), a random access memory (RAM), a magnetic disk, or an optical disk.

Finally, it should be noted that the above embodiments are only specific implementations of the present disclosure, which are used to illustrate the technical solutions of the present disclosure, but not to limit them. The protection scope of the present disclosure is not limited thereto. Although the present disclosure has been described in detail with reference to the foregoing embodiments, those of ordinary skill in the art should understand that any person skilled in the art can still modify the technical solutions described in the foregoing embodiments or make changes that can be easily thought of, or equivalently replace some technical features thereof within the technical scope disclosed in the present disclosure. These modifications, changes or replacements do not make the essence of the corresponding technical solutions deviate from the spirit and scope of the technical solutions of the embodiments of the present disclosure, and should be covered by the protection scope of the present disclosure. Therefore, the protection scope of the present disclosure should be subject to the protection scope of the claims.

1. A search result display method, comprising:
acquiring search results corresponding to target search information in response to receiving the target search information;
acquiring at least one piece of recommended content matching with the target search information in response to a first search result in the search results being a search result that satisfies a first preset condition, wherein any piece of the recommended content comprises recommended search information and a recommended search result corresponding to the recommended search information; and
displaying the first search result at a first display position of a search result page, and inserting the recommended content into a target display position after the first search result for display.

2. The search result display method according to claim 1, wherein the inserting the recommended content into the target display position after the first search result for display comprises:
inserting and displaying the recommended content after the first search result corresponding to the target search information and before another search result corresponding to the target search information.

3. The search result display method according to claim 2, wherein the inserting and displaying the recommended content after the first search result corresponding to the target search information and before the another search result corresponding to the target search information comprises:
displaying target recommended content in the recommended content and first indication information indicating that more pieces of recommended content are triggered to view after the first search result corresponding to the target search information and before the another search result corresponding to the target search information, wherein other pieces of recommended content are displayed after the first indication information is triggered.

4. The search result display method according to claim 2, wherein the inserting and displaying the recommended content after the first search result corresponding to the target search information and before the another search result corresponding to the target search information comprises:
displaying second indication information indicating that subsequent content is the recommended content after the first search result corresponding to the target search information and before the another search result corresponding to the target search information, and sequentially displaying the recommended content under the second indication information.

5. The search result display method according to claim 1, wherein the inserting the recommended content into the target display position after the first search result for display comprises:
sequentially inserting different pieces of recommended content between adjacent search results in a plurality of consecutive search results corresponding to the target search information, wherein the plurality of consecutive search results comprise the first search result.

6. The search result display method according to claim 1, wherein the acquiring of the at least one piece of the recommended content matching with the target search information comprises:
determining at least one piece of recommended search information matching with the target search information according to a pre-established offline mapping relationship between pieces of original search information and the recommended search information, and using a first search result in search results corresponding to the recommended search information as the recommended search result.

7. The search result display method according to claim 6, wherein the pre-established offline mapping relationship between the pieces of original search information and the recommended search information is determined according to the following steps:
determining recommended search information corresponding to the original search information based on semantic information corresponding to search information and a historical search frequency corresponding to the search information, wherein a semantic information similarity between the recommended search information and the original search information satisfies a second preset condition, or semantic information of the recommended search information and semantic information of the original search information indicate a same search type, and a historical search frequency corresponding to the recommended search information reaches a first preset threshold.

8. The search result display method according to claim 1, wherein the acquiring of the at least one piece of the recommended content matching with the target search information in response to the first search result in the search results being the search result that satisfies the first preset condition comprises:
acquiring the at least one piece of the recommended content matching with the target search information in response to the target search information corresponding to an objective answer and the objective answer being the first search result.

9. The search result display method according to claim 8, wherein the acquiring of the at least one piece of the recommended content matching with the target search information in response to the target search information corresponding to the objective answer and the objective answer being the first search result comprises:
acquiring the at least one piece of the recommended content matching with the target search information, in response to the target search information corresponding to the objective answer and the objective answer being the first search result, and a historical search frequency of searching using the target search information reaching a second preset threshold.

10. (canceled)

11. A computer device, comprising: a processor, a memory, and a bus, wherein the memory stores machine-readable instructions executable by the processor; when the computer device is running, the processor communicates with the memory through the bus; and the machine-readable instructions, when executed by the processor, perform the steps of a search result display method and the method comprises:
acquiring search results corresponding to target search information in response to receiving the target search information;
acquiring at least one piece of recommended content matching with the target search information in response to a first search result in the search results being a search result that satisfies a first preset condition, wherein any piece of the recommended content comprises recommended search information and a recommended search result corresponding to the recommended search information; and
displaying the first search result at a first display position of a search result page, and inserting the recommended content into a target display position after the first search result for display.

12. A non-transitory computer-readable storage medium, wherein the computer-readable storage medium stores a computer program, and the computer program, when executed by a processor, performs the steps of a search result display method, and the method comprises:
acquiring search results corresponding to target search information in response to receiving the target search information;
acquiring at least one piece of recommended content matching with the target search information in response to a first search result in the search results being a search result that satisfies a first preset condition, wherein any piece of the recommended content comprises recommended search information and a recommended search result corresponding to the recommended search information; and
displaying the first search result at a first display position of a search result page, and inserting the recommended content into a target display position after the first search result for display.

13. The computer device according to claim 11, wherein the inserting the recommended content into the target display position after the first search result for display comprises:
inserting and displaying the recommended content after the first search result corresponding to the target search information and before another search result corresponding to the target search information.

14. The computer device according to claim 13, wherein the inserting and displaying the recommended content after the first search result corresponding to the target search information and before another search result corresponding to the target search information comprises:
displaying target recommended content in the recommended content and first indication information indicating that more pieces of recommended content are triggered to view after the first search result corresponding to the target search information and before the another search result corresponding to the target search information, wherein other pieces of recommended content are displayed after the first indication information is triggered.

15. The computer device according to claim 13, wherein the inserting and displaying the recommended content after the first search result corresponding to the target search information and before the another search result corresponding to the target search information comprises:
displaying second indication information indicating that subsequent content is the recommended content after the first search result corresponding to the target search information and before the another search result corresponding to the target search information, and sequentially displaying the recommended content under the second indication information.

16. The computer device according to claim 11, wherein the inserting the recommended content into the target display position after the first search result for display comprises:
sequentially inserting different pieces of recommended content between adjacent search results in a plurality of consecutive search results corresponding to the target search information, wherein the plurality of consecutive search results comprise the first search result.

17. The computer device according to claim 11, wherein the acquiring of the at least one piece of the recommended content matching with the target search information comprises:
determining at least one piece of recommended search information matching with the target search information according to a pre-established offline mapping relationship between pieces of original search information and the recommended search information, and using a first search result in search results corresponding to the recommended search information as the recommended search result.

18. The computer device according to claim 17, wherein the pre-established offline mapping relationship between the pieces of the original search information and the recommended search information is determined according to the following steps:
determining recommended search information corresponding to the original search information based on semantic information corresponding to search information and a historical search frequency corresponding to the search information, wherein a semantic information similarity between the recommended search information and the original search information satisfies a second preset condition, or semantic information of the recommended search information and semantic information of the original search information indicate a same search type, and a historical search frequency corresponding to the recommended search information reaches a first preset threshold.

19. The computer device according to claim 11, wherein the acquiring of the at least one piece of the recommended content matching with the target search information in response to the first search result in the search results being the search result that satisfies the preset condition comprises:
acquiring the at least one piece of the recommended content matching with the target search information in response to the target search information corresponding to an objective answer and the objective answer being the first search result.

20. The computer device according to claim 19, wherein the acquiring of the at least one piece of the recommended content matching with the target search information in response to the target search information corresponding to the objective answer and the objective answer being the first search result comprises:
acquiring the at least one piece of the recommended content matching with the target search information, in response to the target search information corresponding to the objective answer and the objective answer being the first search result, and a historical search frequency of searching using the target search information reaching a second preset threshold.

21. The storage medium according to claim 12, wherein the inserting the recommended content into the target display position after the first search result for display comprises:
inserting and displaying the recommended content after the first search result corresponding to the target search information and before another search result corresponding to the target search information.
